(19) United States
(12) Patent Application Publication
(10) Pub. No.: US 2019/0341648 A1
(43) Pub. Date: Nov. 7, 2019

(54) HOLE-CONTAINING ELECTRODE DESIGNS FOR LITHIUM ION BATTERY AND CAPACITOR HYBRID SYSTEMS

(71) Applicant: GM GLOBAL TECHNOLOGY OPERAITONS LLC, Detroit, MI (US)

(72) Inventors: Qiang Wu, Shanghai (CN); Xiusheng Zhang, Shanghai (CN); Xiaochao Que, Shanghai (CN); Jingjing Wu, Shanghai (CN)

(21) Appl. No.: 15/972,294

(22) Filed: May 7, 2018

(51) Int. Cl. H01M 10/0525; H01M 4/38; H01M 4/66; H01M 4/133; H01M 2/16; H01G 11/34; H01G 11/24

(52) U.S. Cl. CPC H01M 10/0525; H01M 4/382; H01M 4/661; H01M 2004/027; H01M 2/1626; H01G 11/34; H01G 11/24; H01M 4/133

(57) ABSTRACT

Lithium-utilizing electrochemical cells, providing hybrid battery and capacitor activity, are formed of one or more lithium battery anodes, one or more lithium battery cathodes, and with at least one capacitor electrode in the cell, with an equal number of electrodes with opposing charges. The respective electrodes are formed of porous layers of one of lithium anode material particles, lithium cathode material particles, or compatible capacitor material particles, formed on both sides of a compatible current collector foil. The capacity and durability of the hybrid cell is enhanced when through-holes are formed through selected electrodes, or through the current collector foils of selected electrodes, to enhance the flow of a non-aqueous liquid electrolyte solution, with its lithium cations and associated anions, to reach both sides of the closely spaced, separated, electrodes in an assembled and operating lithium battery/capacitor hybrid cell.

### TECHNICAL FIELD

Lithium-ion battery anodes and cathodes, formed of porous layers of particulate anode or cathode material, coated on the sides of a current collector foil, are used in combination with like-formed lithium-ion adsorbing capacitor electrodes to form hybrid electrochemical cells. Combinations of the porous battery electrodes and capacitor electrodes are prepared and arranged with interspaced porous separators and infiltrated with a non-aqueous lithium-ion conducting liquid electrolyte solution to provide a predetermined combination of battery and capacitor electrode capacities in each individual hybrid cell. In this disclosure, selected battery electrodes are formed with through-holes, or with current collector foils formed with through-holes, to enable infiltration and penetration of the liquid electrolyte and passage of its lithium ions through the current collectors and into the coatings of particulate electrode materials on both sides of the electrode to minimize capacity loss during repeated charge and discharge cycling of the hybrid cell.

### CROSS-REFERENCES TO RELATED APPLICATIONS

The content of the subject application provides improvements to the operation of the hybrid cell designs disclosed in co-pending application Ser. No. 15/221,963, filed Jul. 28, 2016, and titled Hybrid Cell Design of Alternately Stacked or Wound Lithium Ion Battery and Capacitor Electrodes. This co-pending application is assigned to the same assignee as the subject application. Portions of the text of the earlier co-pending application are included in the subject application.

The content of the subject application may also provide improvements to the operation of the hybrid cell designs disclosed in the co-pending application Ser. No. 15/695,050, filed Sep. 5, 2017, and titled Electrode Designs for Lithium Ion Battery and Capacitor Hybrid System. This co-pending application is assigned to the same assignee as the subject application. Portions of the text of the earlier co-pending application are included in the subject application.

### BACKGROUND OF THE INVENTION

The material presented as background information in this section of the specification is not necessarily prior art.

Electric-powered automotive vehicles use multi-cell batteries to provide electrical energy for providing electrical power for driving the vehicle and for providing electrical energy to many devices on the vehicle. Batteries comprising many lithium-ion electrochemical cells are examples of such electrical power sources. And such batteries are used in many non-automotive applications.

In some applications, it may be useful to combine lithium-ion battery electrodes with capacitor electrodes in a hybrid electrochemical cell. For example, one or more such positive or negative capacitor electrodes may be charged during braking or other operation of the vehicle and the stored electrical charge used in combination with the discharging of complementary functioning lithium battery electrodes of the hybrid cell.

There is a need for improved practices to prepare and assemble a combination of cooperating lithium ion battery electrodes and capacitor electrodes in a hybrid cell in accordance with specified functional capacity requirements of each unique hybrid cell.

### SUMMARY OF THE INVENTION

In accordance with practices of this invention, particulate anode and cathode materials for lithium-ion batteries are used in varying combinations with compatible capacitor materials to form alternating assembled battery electrodes and capacitor electrodes for hybrid electrochemical cells to conveniently provide different predetermined combinations of lithium-ion battery properties and capacitor properties. The electrodes are formed by depositing particles of electrode materials on both sides of a compatible metallic current collector foil. In an assembled cell, a stack or roll of the electrodes is infiltrated with a non-aqueous liquid electrolyte solution containing lithium cations and corresponding anions. Such combinations of lithium ion battery electrodes and capacitor electrodes can be adapted and arranged to produce different, useful combinations of energy densities (Wh/kg) and power densities (W/kg) in a hybrid electrochemical cell that better adapts its use in different applications. In the following text, the battery anode is often referred to as the negative electrode (as it is during cell discharge) and the battery cathode is often referred to as the positive electrode (as it is during cell discharge). One or more positively charged or negatively charged capacitor electrodes are suitably grouped with the battery anode electrodes and/or the battery cathode electrodes. The capacitor material electrode(s) will have the same charge as the battery electrode with which it is electrically connected in the hybrid cell.

In each hybrid cell of this invention there will be at least two electrically-connected negative electrodes alternating in an assembly with two electrically-connected positive electrodes. And there will be an equal number of negative and positive electrodes in the hybrid cell. For example, a hybrid electrochemical cell may consist of two negative electrodes of lithium intercalating anode material and one positive electrode of lithium-intercalating cathode material and one positive electrode of capacitor material. Adjacent electrodes are physically separated by thin, like-shaped, porous separator sheets.

In accordance with an important aspect of this invention, detailed attention is given to balance the flow of lithium ions through the liquid electrolyte solution of the hybrid cell between closely-spaced, battery electrodes and capacitor electrodes of opposing electrical charge. This is accomplished by adjusting the amounts and locations of the respective electrode materials so as to proportion the lithium-ion adsorbing or utilizing capacity of the electrode materials which are releasing and adsorbing lithium ions during each charge and discharge cycle of the hybrid cell. And it is accomplished by forming holes through selected electrodes, or through the current collector supporting the porous electrode materials, to enhance the flow of the electrolyte and its ions through the electrodes.

In general, each electrode is formed of a suitable metallic current collector foil that is coated on both sides with a porous layer of micrometer-size particles of active lithium ion battery anode particles, or of lithium ion battery cathode particles, or with a porous layer of like-wise sized capacitor particles. In forming the porous electrode layers, the particles of electrode materials may be resin-bonded to each other and to current collector foil surface.

Each such two-side coated electrode is typically less than a millimeter in thickness. And each electrode is shaped in its other two dimensions so that alternating positively-charged and negatively-charged electrodes may be assembled with interposed thin, porous separator layers in the formation of a hybrid battery/capacitor electrochemical cell. Such a hybrid cell may be formed of a stack of equal numbers of like-shaped (typically rectangular shaped) alternating positive and negative electrodes and separators. In a different cell assembly method, the cell may be formed by winding like-shaped (typically long rectangular strips) alternating two-sided positive and negative electrodes and separators layers into rolled assemblies. In an assembled cell, the micro-pores of the alternating electrodes and separators are filled with a lithium cation-conducting electrolyte composed of one or more lithium salts (such as LiPF₆) dissolved in a non-aqueous liquid electrolyte that functions at the required operating temperature range of the hybrid cell. In accordance with practices of this invention, suitable holes are formed through selected electrodes, or through the current collectors of selected electrodes, to enhance the infiltration of the liquid electrolyte into and through the pores of the closely spaced electrode material layers and better accommodate the necessary flow of lithium ions through and between the electrode materials during operation of the hybrid cell.

By way of non-limiting illustrative examples, suitable anode materials include graphite particles or lithium titanate particles (Li₄Ti₅O₁₂, LTO); a suitable cathode material is particles of LiMn₂O₄ (LMO), LiNiₓMn_{y}Co_{(1-x-y)}O₂ (NMC) or particles of LiFePO₄ (LFP); and a suitable capacitor material is particles of activated carbon (AC). In the operation of a hybrid cell, the anode particles and cathode particles interact with the electrolyte to alternately intercalate and de-intercalate lithium ions (Li+), positively charged capacitor electrode particles alternately adsorb and desorb anions (such as PF₆⁻), and negatively charged capacitor electrode particles alternately adsorb and desorb cations (such as Li⁺).

The hybrid system has two types of capacitor arrangements. One is where the capacitor electrode is electrically connected with a battery electrode (herein designated, LIC). For example, if an anode electrode (LTO particles) is facing a capacitor (AC particles) of opposite charge which is connected with a cathode, the anode will alternately intercalate and de-intercalate lithium ions and the capacitor will de-absorb and absorb corresponding anions (e.g., PF₆⁻) during charge/discharge. Another capacitor assembly is an electrochemical double layer capacitor (EDLC) in which both adjacent positive and negative electrodes are capacitors (which are further paired with a battery electrode or electrodes in a hybrid cell). In an EDLC, the cathode capacitor absorbs/desorbs PF₆⁻ and the anode capacitor adsorbs/desorbs Li⁺ during the repeated charge/discharge cycling.

In general, the process of ionic intercalation/de-intercalation occurs throughout the whole volume of the selected particulate battery electrode material. But the porous particulate electrode material of each electrode in a closely assembled hybrid cell must have suitable access to lithium ions or corresponding anions in the surrounding liquid electrolyte. A gram of battery electrode material can usually intercalate a greater amount of lithium ions than are adsorbed on the surfaces of a like amount of capacitor particles. But the release of lithium ions from battery electrode particles is typically slower than the release of lithium ions from selected capacitor particles. The battery particles are typically capable of producing a greater energy density (Wh/kg) per gram than capacitor particles, but the capacitor particles release adsorbed lithium ions faster and are typically capable of providing a greater power density (W/kg) than battery particles.

The amounts of the respective electrode materials are determined by the cell design with its intended requirement of energy density and power density. The selected compositions of the anode, cathode, and capacitor materials have known molar or weight capacities to interact with the lithium cations and the associated anions of the selected electrolyte. And the observed capacities of the particles of the electrode materials, in their bonded layers on a current collector foil may be confirmed experimentally. The capacity of battery electrode material may be determined by its molar content (mAh/g) and actual weight loading. For example, the specific capacity of lithium titanate (LTO) electrode particles is about 160 mAh/g and the specific capacity of lithium manganese oxide (LMO) electrode particles is 110 mAh/g. The capacity and amount of capacitor material may also be determined by its molar content or weight. For example, the specific capacity of activated carbon capacitor particles is about 30 mAh/g. Sometimes an N/P ratio is used in this specification. The N/P ratio refers to the negative electrode capacity (anode during cell discharge) to positive electrode capacity (cathode capacity).

In stacked or folded assemblies of alternating anode and cathode layers and interposed separator layers it is necessary to provide for suitable infiltration and penetration of the porous layers of particulate electrode materials and capacitor materials, bonded to their respective current collector foils, with the liquid electrolyte such that sufficient access of lithium cations and corresponding anions is provided to the respective battery and capacitor materials so the inherent capacities of these materials are properly utilized. With closely-spaced, like-shaped battery and capacitor layers, enclosed at their peripheries, the infiltration of the electrolyte in the assembled porous medium and the flow of the lithium cations and corresponding anions in the electrolyte solution may be impeded to the decrement of efficient cell operation. It is desired to improve the contact of the liquid electrolyte and its ions with each layer of particulate electrode material in the hybrid battery/capacitor cell.

In accordance with practices of this disclosure, a suitable number of suitably-sized, through-holes (typically many micrometer-size holes) are formed through the current collector foils of some selected electrodes or all of the electrodes in the hybrid cell. The number and size of the through-holes are determined to allow suitable flow of the liquid electrolyte directly through the current collector foils (and the bonded porous layers of electrode material) so as to provide improved access of lithium cations and corresponding anions to each layer of battery and capacitor electrode materials while retaining suitable current flow into and from each current collector. In this embodiment, for example, the holes of suitable number, size, and shape are formed in the copper or aluminum current collector foil before the appropriate porous layers of battery or capacitor electrode material particles are applied and bonded to the thin foils (often 5-30 micrometers in thickness). For example, micrometer-size holes (suitably 5-5000 μm, preferably about 20-200 μm in diameter or largest dimension) are mechanically punched (or formed by use of laser beams) through the foil in a generally uniform pattern over the main surface of the foil to which the selected electrode material is to be applied. Of course, the shape and dimensions of the foil are determined by the nature and capacity of the electrode. The shapes of the holes may depend on how they are formed. A rectangular current collector foil (e.g., 50 mm by 55 mm) may contain hundreds of such through-holes uniformly distributed over its surfaces intended to carry electrode material. Generally, tabs on current collectors for electrical connection with other electrodes need not be formed with through-holes. A uniformly-thick layer of electrode particles (for example, up to about 100 micro-meters in thickness) is then applied to each of the opposing surfaces of the perforated foil. In an assembled cell, the perforated current collector foil serves to retain sufficient current carrying capacity for cell operation, while the lithium-ion conducting liquid electrolyte can flow through the holes in the current collector to interact with particulate electrode layers on both sides of the electrode and the facing electrodes.

In a different embodiment, through-holes are formed completely through some of the formed electrodes. Each hole extends through the opposing porous layers of particulate electrode material and the current collector foil to which the layers are bonded. This embodiment is typically selectively used in the preparation of a battery electrode that is positioned adjacent to a capacitor electrode, such as a capacitor electrode formed with a porous layer of activated carbon (AC) particles. Again, the holes are punched, or otherwise formed, in numbers, patterns, and sizes to accommodate the flow of electrical current to and from the battery electrode operation as well as to assure adequate flow of the liquid electrolyte and its ions from one side of the electrode to the other side.

In general, the hybrid battery/capacitor cells are assembled with at least four electrodes, a pair of positive electrodes and an interposed pair of negative electrodes. Larger cells with equal numbers of positive and negative electrodes may be assembled. A hybrid battery/capacitor cell will contain at least one capacitor electrode electrically connected with a like-charged battery electrode. For example, a hybrid battery/capacitor cell may be formed with two electrically connected lithium titanate (LTO) anodes and a positively charged activated carbon (AC) capacitor electrically connected to a lithium manganese oxide (LMO) cathode. One LTO anode is positioned between the AC capacitor and the LMO cathode. The electrodes are like-shaped and like-sized (although the anodes may be slightly larger than the cathode and capacitor. And the electrodes are placed face-to-face with interposed porous polymeric separator layers. By way of a second, non-limiting example, a hybrid battery/capacitor cell may comprise an assembly of (1) a LMO cathode facing (2) a LTO anode facing (3) a positively-charged (during cell discharge) AC (+) capacitor facing (4) a negatively-charged AC (−) capacitor facing (5) a LMO cathode facing (6) a LTO anode. This combination of facing positively-charged and negatively-charged capacitors is known as an electrochemical double layer capacitor (EDLC). The respective six electrodes in the hybrid cell are suitably like-sized and shaped, and separated by folded porous separator layers or by a suitable number of individual separator layers.

In a first embodiment of the use of through-hole-containing current collector foils, each electrode in a hybrid battery/capacitor cell is formed using a through-hole-containing current collector foil to facilitate the transfer of a liquid, lithium-ion containing electrolyte through each current collector foil and the porous layers of particulate electrode material bonded to the hole-containing current collector. The use of the through-holes in each current collector is exploited to enable the flow and conduction of lithium ions in the liquid electrolyte to make full use of the inherent capacity of each electrode and to decrease the occurrence of irreversible capacity in one or more electrode material layers.

In a second embodiment of the use of through hole-containing current collector foils, the practice is limited to the use of the perforated current collector foils in battery material electrodes which face a capacitor electrode. In the above example of a four-member hybrid cell, only the two LTO electrodes facing the positively charged AC (+) capacitor electrode would use a perforated current collector foil. In the above example of the six-member hybrid cell, the LTO anode facing the AC (+) capacitor electrode and the LMO cathode facing the AC (−) capacitor electrode would use perforated current collector foils.

In a third embodiment of the use of practices of this disclosure, selected electrodes are formed with a determined pattern of holes extending through the full electrode layers and the current collector of selected electrodes. For example, such through-hole-formed electrodes would be used in battery electrodes facing a capacitor electrode in an assembled hybrid battery/capacitor cell. In the above example of a four-member hybrid cell, only the two LTO electrodes facing the positively charged AC (+) capacitor electrode would be formed as through-hole-containing electrodes. And in the above example of the six-member hybrid cell, the LTO anode facing the AC (+) capacitor electrode and the LMO cathode facing the AC (−) capacitor electrode would be formed as through-hole-containing electrodes.

Other objects and advantages of practices of this disclosure will be apparent from the following descriptions of preferred embodiments of the invention.

### BRIEF DESCRIPTION OF THE DRAWINGS

FIG. 1A illustrates a plan view of a metal foil current collector in which a regular pattern of rows of closely-spaced, like-sized round holes have been formed. As illustrated the holes are distributed uniformly over the surface of the foil to be coated with particles of active battery electrode material or capacitor material. FIG. 1B further illustrates a plan view (partly broken away), and FIG. 1C, the side view, of the electrode after a porous coating layer of particles of electrode material has been applied to the through-hole-containing current collector foil. In each of the drawing figures the through-holes are schematically illustrated for visualization as somewhat larger than they would be formed in working electrodes.

FIG. 2A is an enlarged schematic side edge view, in cross-section, of the four electrodes in a hybrid lithium battery/capacitor cell. In this and following views, the separators and the liquid electrolyte which would be present in an assembled hybrid cell are not shown for purposes of simplification of the illustration of the hybrid cells and for easier focus on the construction and arrangement of the electrodes. In FIG. 2A, the hybrid cell has two negatively-charged lithium titanate (LTO) electrodes, a positively-charged lithium manganese oxide (LMO) cathode and a positively-charged, activated carbon (AC) capacitor electrode. The current collector foils are depicted in cross-section to illustrate their through-holes, and the holed current collectors are coated on both major sides with a porous layer of the specified electrode material particles.

FIG. 2B is an enlarged schematic side view, in cross-section, of the six electrodes in a hybrid lithium battery/capacitor cell. This hybrid cell has two negatively-charged (LTO) electrodes with an interposed negatively-charged AC capacitor electrode and two positively-charged LMO cathodes and an interposed positively-charged, AC capacitor electrode. The electrodes with their current collector foils are schematically illustrated in cross-section to illustrate their through-holes, and the holed current collectors are coated on both major sides with a porous layer of the specified electrode material particles.

FIG. 3A is an enlarged schematic side edge view, in cross-section, of the four electrodes in a hybrid lithium battery/capacitor cell. The hybrid cell has two negatively-charged lithium titanate (LTO) electrodes, a positively-charged lithium manganese oxide (LMO) cathode and a positively-charged, activated carbon (AC) capacitor electrode. In this illustration the electrode material-coated sides of the respective electrodes are numbered. In this illustrated embodiment, only the two LTO anodes (with sides labelled 3, 4, 7, and 8) facing the AC capacitor (sides 5,6) have current collectors with through-holes.

FIG. 3B is an enlarged schematic side edge view, in cross-section, of the six electrodes in a hybrid lithium battery/capacitor cell. This hybrid cell has two negatively-charged (LTO) electrodes with an interposed negatively-charged AC capacitor electrode and two positively-charged LMO cathodes and a positively-charged, AC capacitor electrode. In this illustrated embodiment, only the LTO electrode (with electrode material-coated sides labelled 3,4) facing the positively-charged AC capacitor (sides 5,6) and the LMO cathode (sides 9,10) facing the negatively-charged AC capacitor (sides 7,8) have current collectors with through-holes.

FIG. 4A is an enlarged schematic side edge view, in cross-section, of the four electrodes in a hybrid lithium battery/capacitor cell. The hybrid cell has two negatively-charged lithium titanate (LTO) electrodes (sides 3,4,7,8), a positively-charged lithium manganese oxide (LMO) cathode (sides 1,2) and a positively-charged, activated carbon (AC) capacitor electrode (sides 5,6). In this illustrated embodiment, the two LTO electrodes are formed with through-holes that extend through each whole electrode. This illustrated practice is usually limited to the making of battery electrodes which are intended to located adjacent to a capacitor electrode.

FIG. 4B is an enlarged schematic side view, in cross-section, of the six electrodes in a hybrid lithium battery/capacitor cell. This hybrid cell has two negatively-charged (LTO) electrodes with an interposed negatively-charged AC capacitor electrode and two positively-charged LMO cathodes and a positively-charged, AC capacitor electrode. In this illustrated embodiment, the LTO electrode (with sides labelled 3,4) facing the positively-charged AC capacitor (sides 5,6) and the LMO cathode (sides 9,10) facing the negatively-charged AC capacitor (sides 7,8) are formed with through-holes that extend through each whole electrode. Again, this practice is usually limited to the making of battery electrodes which are intended to located adjacent to a capacitor electrode.

FIG. 5 is a bar graph presenting Coulombic Efficiency (%) values for like-composed hybrid cells [LIB+8%LIC], one with through-hole containing electrodes (scattered dots) and one with non-holed electrodes (dense dots). The specific cells were charged and discharged three times at 25° C. at current flow amounts of 27 mA (20% of the as-formed capacity of the cells, 0.2/0.2C). The capacitor electrode capacity was 8% of the total cathode capacity of the cells. The comparative coulombic efficiency (%) data is presented after the first, second, and third charge-discharge cycles.

FIG. 6 is a graph illustrating Voltage (V) change (vertical axis) after full charge versus Rest Time (s) for like-composed hybrid cells [LIB+8%LIC], one cell with through-hole containing electrodes and one cell with non-holed electrodes. The comparative voltage change data is presented during 0.5 h rest time after full charge at the first and second charge-discharge cycles.

### DESCRIPTION OF PREFERRED EMBODIMENTS

The electrodes of lithium-ion cells are often formed by bonding particles of active electrode materials that have a largest dimension in the range of about 0.5 to 30 micrometers to a compatible metal current collector foil having a thickness of about 5 to 30 micrometers. The electrode material particles are bonded in a porous layer of generally uniform thickness on a major surface (in this specification, preferably both surfaces) of the current collector foil so that the layer(s) can subsequently be infiltrated with an electrolyte solution. As stated, the shape of the current collector is often rectangular with side dimensions that provide a predetermined surface area to enable it to support a predetermined quantity of electrode material for a lithium-ion battery electrode or capacitor electrode member. Preferably, each side of the current collector foil is coated with a porous layer of particles of electrode material in which the sustainable thickness of each layer is usually limited to about 5 μm to 250 μm. In accordance with practices of this invention, holes are formed in each electrode, or selected electrodes. As stated above and as will be described in more detail in the specific examples of this specification, the formed holes may extend completely through an electrode, that is the holes extend through both the current collector and through each layer of porous particulate electrode material bonded to the sides of the current collector. In other embodiments, the through-holes are formed only in the current collector foils on which the porous layers of electrode materials are bonded.

Before proceeding with examples of through-hole containing current collectors and electrodes, non-limiting examples of suitable materials for the battery electrodes and capacitor electrodes will be provided.

A few examples of suitable battery electrode materials for an anode electrode (negative battery electrode during discharge of the cell) of a lithium ion cell are particles of graphite, some other forms of carbon, silicon, alloys of silicon with lithium or tin, silicon oxides (SiOx), metal oxides, and lithium titanate. During cell-discharge, electrons are released from the anode material into the electrical power-requiring external circuit and lithium ions are released (de-intercalated) into an anhydrous lithium ion conducting electrolyte solution. Typically, particles of lithium-ion cell anode materials are resin-bonded as a porous layer onto one or both sides of a copper current collector foil. Lithium titanate particles may be resin bonded to either a copper current collector foil or to an aluminum current collector foil. A small amount of electrical conductivity enhancing carbon particles may be mixed with the anode particles.

Examples of positive battery electrode materials (cathode), used in particulate form, include lithium manganese oxide, lithium nickel oxide, lithium cobalt oxide, lithium nickel manganese cobalt oxide, other lithium-metal-oxides, and lithium iron phosphate. Other materials are known and commercially available. One or more of these materials may be used in an electrode layer. Typically, particles of lithium-ion cell cathode materials are resin-bonded to one or both sides of an aluminum current collector foil. A small amount of conductivity enhancing carbon particles may be mixed with the cathode particles.

In addition to activated carbon particles, suitable capacitor cathode and anode materials include, in particulate form, for example:

Metal Oxides, MOx, where M=Pb, Ge, Co, Ni, Cu, Fe, Mn, Ru, Rh, Pd, Cr, Mo, W, Nb.

Metal Sulfides, such as TiS₂, NiS, Ag₄Hf₃S₈, CuS, FeS, FeS₂.

Other various forms of carbon particles, such as activated carbon fibers, graphite, carbon aerogel, carbide-derived carbon, graphene, graphene oxide, and carbon nanotubes. More than one type of carbon may be used in a blended capacitor material. The same carbon material may be used in both the anode and cathode in an electric double-layer capacitor (EDLC).

Particles of one or more of the following polymers may be used as capacitor material in the cathode of the cell; poly (3-methyl thiophene), polyaniline, polypyrrole, poly(paraphenylene), polyacene, polythiophene, and polyacetylene.

The capacitor particles or lithium-ion battery anode particles or cathode particles are coated or otherwise suitably combined with a suitable amount of a bonding material. For example, the particles may be dispersed or slurried with a solution of a suitable resin, such as polyvinylidene difluoride dissolved in N-methyl-2-pyrrolidone, and spread and applied to a surface of a current collector in a porous layer. The current collector may have through-holes as described in this specification. Other suitable binder resins include carboxymethyl cellulose/styrene butadiene rubber resins (CMC/SBR) or polytetrafluoroethylene (PTFE). The binders are not electrically conducive and should be used in a minimal suitable amount to obtain a durable coating of porous electrode material without fully covering the surfaces of the particles of electrode material.

In many battery constructions, the separator material is a porous layer of a polyolefin, such as polyethylene (PE), polypropylene (PP), non-woven, cellulose/acryl fibers, cellulose/polyester fibers, or glass fibers. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer is used to prevent direct electrical contact between the facing negative and positive electrode material layers and is shaped and sized to serve this function. In the assembly of the cell, the facing major faces of the electrode material layers are pressed against the major area faces of the separator membrane. A liquid electrolyte is typically injected into the pores of the separator and electrode material particulate layers.

The electrolyte for a subject hybrid lithium-ion battery/capacitor cell may be a lithium salt dissolved in one or more organic liquid solvents. Examples of suitable salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and solvent is selected for providing suitable mobility and transport of lithium ions in the operation of the hybrid cell with its battery and capacitor electrode combinations. The electrolyte is carefully dispersed into and between closely spaced layers of the electrode elements and separator layers.

In general, it is preferred to combine cell units to form a hybrid electrochemical cell producing an energy density in the range of 20 Wh/kg to 200 Wh/kg and a power density in the range of 500 W/kg and 10,000 W/kg. Values of energy density and power density depend on the composition of the battery electrode materials and of the capacitor electrode materials, and on the ratio of contents of battery electrode materials and capacitor electrode materials. In general energy density is improved by increasing battery material content and/or by selecting high specific energy battery electrode materials. And the power density of the hybrid electrochemical cell is increased by increasing the content of capacitor electrode material and/or by selecting high specific power density capacitor compositions. The use of combinations of the subject cell units of variable even numbers is a convenient and effective method of preparing and using building units to produce one or more hybrid electrochemical cells having a desired combination of energy density and power density properties. And the use of through-holes in selected electrodes or their current collectors enhances the function and stability of the hybrid cells.

As stated, selected electrodes, incorporated into an assembled hybrid lithium battery/capacitor cell may have been formed with a pattern of through-holes that extend through the porous layers of particulate electrode material and the current collector to which the opposing layers of electrode material are bonded. Or selected electrodes, will be formed using a current collector foil with through-holes formed in the potion of the foil to which the porous layers of electrode material are bonded.

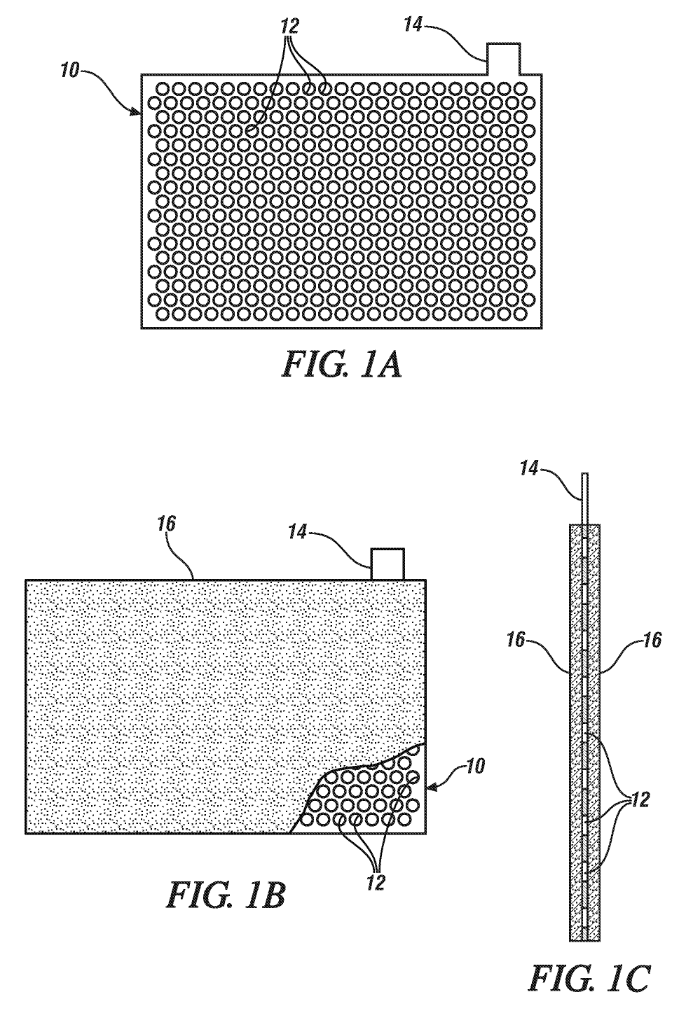

In FIG. 1A, a portion of a metal current collector foil 10 is illustrated which has been formed with many through-holes 12 extending through the thickness of the foil over surface regions of the foil 10 which are intended to be coated with, for example, a resin-bonded, porous layer of electrode material suitable for the anode or the cathode of a lithium battery, or with material for a positive or negative capacitor electrode to be used in combination with lithium battery electrodes in a hybrid electrochemical cell with a lithium-ion conducting liquid electrolyte solution. Current collector foil 10 will usually have a tab member 14 at one of its sides. Tab 14 is sized and shaped for electrical connection with other electrodes (typically like-charged electrodes) in the hybrid cell. Tab 14 is typically not coated with electrode material, nor formed with through-holes. At described in this specification, current collector foil 10 may be formed, for example, of highly electrically conductive aluminum, copper, or other suitable flexible and conductive metal. Depending on the structural and functional requirements of the hybrid cell, such aluminum foils typically have a thickness in the range of about 5 to 25 μm and copper foils have a thickness in the range of about 4 to 15 micrometers.

The through-holes 12 may be formed by mechanical punching, penetration with a laser beam, or other suitable hole-forming means. Through-holes 12 are schematically illustrated as being round and relatively large but may have other shapes adapted to the function of the electrode. Small round or square shapes typically serve to permit suitable infiltration by a liquid electrolyte solution for the transport of lithium cations and corresponding anions through the porous electrode material. Suitably, the holes have diameters or largest dimensions in the range of 5-5000 and often preferably in the range of about 30-200 depending on the overall area of the current collector.

In the schematic illustration of FIGS. 1B and 1C, the principle areas of both sides of current collector foil 10 have been suitably coated with a porous layer of particulate electrode material 16. Often the thickness of each layer of electrode material 16 is in the range of about 20 μm to 100 μm. Preferably, tab 14 is left un-coated. As stated above in this specification, and illustrated in the following examples, lithium battery anodes and cathodes, as well as positive and negative capacitor electrodes, may be thus formed with flow-through-hole extending through their current collector members.

In other embodiments of this invention, an electrode member for the hybrid battery/capacitor cell may be formed with a normal current collector foil as the initial support for the opposing, bonded layers of battery or capacitor particles. Through-holes may thereafter be punched, or otherwise suitably formed, through both layers of the electrode material (e.g., layers 16 in FIGS. 1B and 1C) and the supporting current collector foil.

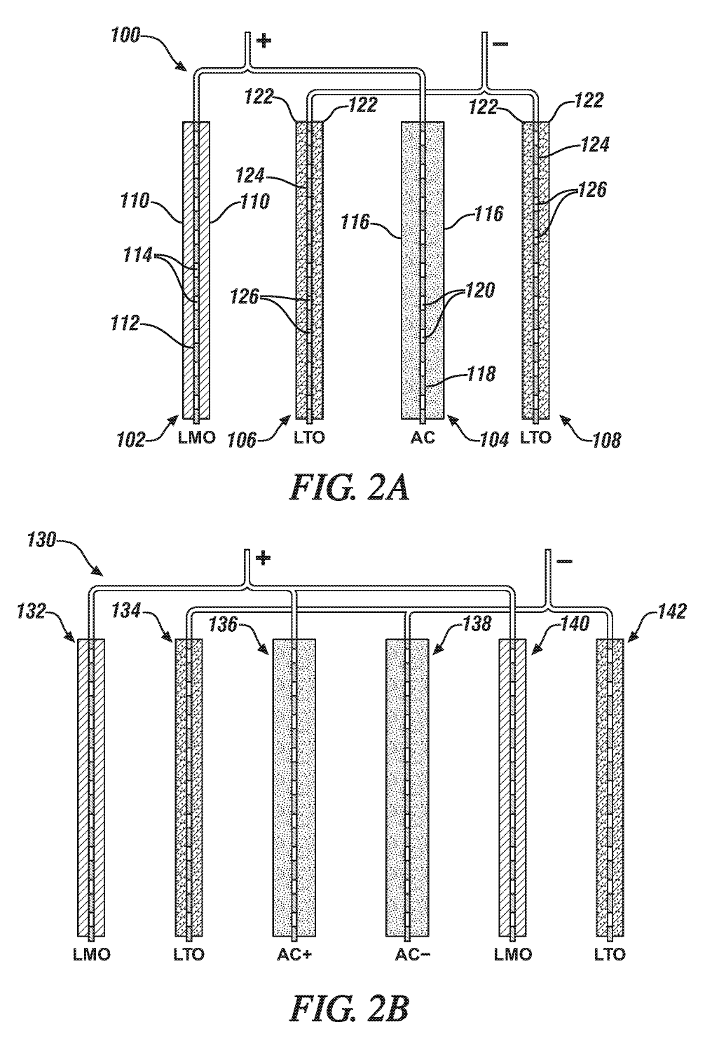

FIG. 2A presents a schematic side-view in cross-section of a first hybrid cell 100 formed of a LMO (lithium manganese oxide) lithium ion battery cathode 102 electrically connected to an activated carbon capacitor (AC) 104. Hybrid cell 100 further comprises a first lithium titanate (LTO) anode 106 electrically connected to a second LTO anode 108. In the assembly of this hybrid cell 100, the AC capacitor 104 is positioned between the two LTO electrodes 106, 108.

As stated above in this specification, each electrode may have a like rectangular two-dimensional shape with an overall thickness, typically less than about two hundred fifty micrometers. And in such an assembled hybrid cell (not illustrated in FIG. 2A), a thin, porous, like-shaped, polymeric separator layer (such as described above in this specification) would be placed between the facing sides of each electrode such that no direct physical contact can occur between adjacent electrodes. The electrodes and interposed separators would typically be assembled in a stack in which the adjacent members of the cell are in touching contact. One or more such hybrid cells of such electrodes and separators would typically be infiltrated with a suitable non-aqueous, liquid, lithium-ion conducting electrolyte (such as described above in this specification) and contained as a package in a pouch or other suitable container. Only positive and negative tabs or tab-connectors would typically be extending outside the container of the hybrid lithium-ion battery/capacitor cell members. Fur purposes of simplification of the descriptions of the hybrid cell illustrated in FIG. 2A, as well as the cells illustrated in FIGS. 2B, 3A, 3B, 4A, and 4B, only the electrode members are illustrated and in spaced-apart arrangement to more clearly and easily describe the use of through-hole-containing current collectors and electrodes in accordance with preferred and illustrative non-limiting embodiments of the invention.

In FIG. 2A, the LMO cathode 102 is formed of a porous layer of resin-bonded particles of lithium manganese oxide 110 bonded to each side of an aluminum current collector foil 112. In this embodiment, current collector foil 112 was pre-formed with many micrometer-size, punctured through-holes 114 distributed generally uniformly over its LMO coated 110 surfaces. Thus, the LMO cathode 102 is formed to readily permit infiltration of the opposing bonded porous layers of LMO electrode material 110 on the current collector foil 112 with a liquid lithium cation conducting electrolyte (not illustrated in the drawing figures), and passage of the electrolyte through the holes 114 in the current collector foil 112.

Paired and electrically connected with LMO cathode 102 is a capacitor 104, formed of a layer of activated carbon (AC) particles 116, resin-bonded to each major surface of aluminum foil current collector 118. Current collector foil 118 was pre-formed with many micrometer-size, punctured through holes 120 distributed generally uniformly over its AC coated 116 surfaces. Thus, the AC capacitor is also formed and structured to permit infiltration of lithium ion-conducting electrolyte in the AC particle 116 layers and passage of the electrolyte through the holes 120 in the current collector foil 118. As illustrated in FIG. 2A, the LMO cathode 102 and the AC capacitor are electrically connected in hybrid cell 100. Such a connection would typically be accomplished through suitable uncoated tabs on their current collectors 112, 118.

Two electrically connected LTO anode members 106, 108 complete the assembly of electrodes in hybrid cell 100. The LTO anode members 106, 108 may be of substantially identical composition and construction. In the embodiment of FIG. 2A, each LTO anode is formed of a porous layer of lithium titanate (LTO) particles 122, resin-bonded to each side of a current collector foil 124. In an LTO anode, the current collector foil 124 may be formed of aluminum or copper with a thickness in the micrometer range. In this embodiment, each current collector foil 124 is pre-formed with many micrometer-size, punctured through-holes 126 distributed generally uniformly over its LTO coated surfaces.

Thus, the LTO anodes 106, 108 are also formed and structured to permit infiltration of lithium ion-conducting electrolyte in the LTO particle 122 layers and passage of the electrolyte through the through-holes 126 in the current collector foils 124. As illustrated in FIG. 2A, the LTO anodes 106, 108 are electrically connected in hybrid cell 100. Such a connection would typically be accomplished through suitable uncoated tabs on their current collectors 124.

In the hybrid cell 100 of FIG. 2A, the respective electrodes are sized and shaped in accordance with known procedures to provide a predetermined balance of battery capacity and capacitor capacity.

In the following drawing figures, the respective electrode materials (LMO, LTO, and AC) and their current collectors are composed like those described in FIG. 2A. The respective electrodes differ mainly with respect to whether they are formed with through-holes.

FIG. 2B illustrates a second embodiment of a hybrid cell 130 composed of two like LMO cathode members 132, 140 electrically connected with a positively-charged AC capacitor electrode 136 and two like LTO anode members 134, 142 electrically connected with a negatively charged AC capacitor electrode 138. As illustrated in FIG. 2B, each electrode member is constructed like the electrodes described in FIG. 2A. The respective porous layers of particles of electrode material are bonded to the major surfaces of electrically compatible current collector foils. The current collector foil in each electrode was pre-formed with many micrometer-size, punctured through-holes distributed generally uniformly over its electrode-material coated surfaces. Thus, each electrode in the hybrid cell 130 of FIG. 2B has been formed such that the liquid lithium ion-conducting electrolyte can flow through the current collector of each electrode as well permeate the porous layers of electrode materials on each electrode.

The six-member hybrid cell of FIG. 2B is assembled with facing capacitor members, AC⁺ 136, AC⁻ 138 that function with opposing charges. This combination of capacitor electrodes functions as an electrochemical double layer capacitor (EDLC).

Thus, in the hybrid cell embodiments illustrated schematically in FIGS. 2A and 2B, each battery electrode and capacitor electrode are formed by depositing the respective particles of electrode material on a current collector foil which contained suitable sized and shaped, pre-formed holes distributed between the major surfaces of the foil.

In general, with respect to the hybrid cell embodiment of FIG. 2A, it is preferred that the capacity of the LMO electrode 102 plus one-half the capacity of the AC electrode 104 be in the range of 1.3 to 0.8 times the capacity of the interposed LTO anode 106. These capacities are determined by the compositions and sizes of the respective electrodes. And with respect to the hybrid cell embodiment of FIG. 2B, with its paired AC+ and AC− capacitor electrodes 136, 138, it is preferred that the capacity of the LMO cathode 140 and one-half the capacity of the AC+ electrode on opposite sides of an LTO anode 134 be in the proportion of LMO+one-half the capacity of the AC cell equals 1.3 to 0.8 times the capacity of the LTO anode. And it is preferred that the hole sizes in current collector foils be in the range of 5 to 5000 μm and that the total hole area be about 0.1 to 50% of the area of the current collector foil to be coated with electrode material.

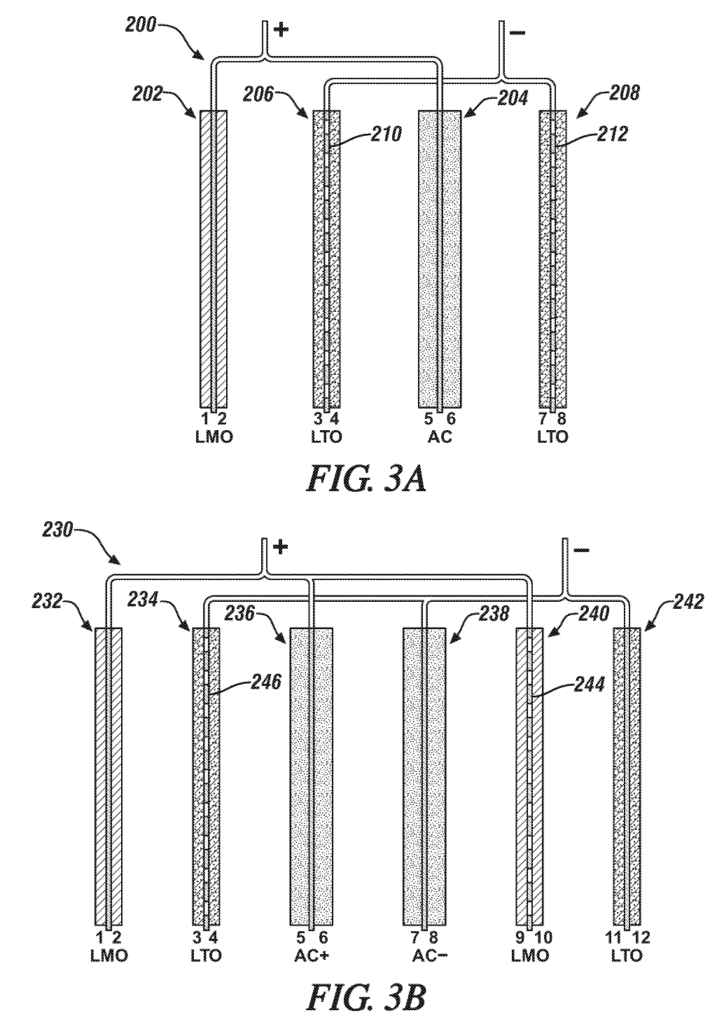

In the embodiments of like electrode-member-containing hybrid cells schematically illustrated in FIG. 3A and 3B, the use of through-hole-containing current collectors is limited to lithium battery electrodes assembled next to a capacitor electrode.

In FIG. 3A, the hybrid cell 200 has two negatively-charged lithium titanate (LTO) electrodes 206, 208, a positively-charged lithium manganese oxide (LMO) cathode 202 and a positively-charged, activated carbon (AC) capacitor electrode 204. In this illustrated embodiment, only the two LTO anodes 206, 208 have current collectors with through-holes 210, 212. The LMO cathode 202 and its electrically-connected AC capacitor 204 are formed with their respective particulate battery and capacitor compositions bonded as porous electrode layers to both sides of solid (no through-hole-containing) current collector foils.

It is found the function and durability of hybrid cell 200 is enhanced when the flow of lithium ions into and out of the LTO anodes 206, 208 facing the AC capacitor 204 is enhanced by the through-hole-containing copper current collector foils 210, 212 used in these battery electrodes. Lithium cations are intercalated into and out of the LTO electrodes 206, 208 while lithium cations are adsorbed into released from the activated carbon particles of the AC capacitor. These different transport requirements of lithium cations and the corresponding electrolyte anions between the battery electrodes 206, 208 and capacitor electrode 204 are preferably enhanced by the use of suitable through-hole structures in the LTO current collectors 210, 212.

In FIG. 3B the hybrid cell 230 has two negatively-charged (LTO) electrodes 234, 242 with an interposed negatively-charged AC capacitor electrode 238 and two positively-charged LMO cathodes 232, 240 and a positively-charged, AC capacitor electrode 236. In this illustrated embodiment, only the LTO electrode 234 facing the positively-charged AC capacitor and the LMO cathode 240 facing the negatively-charged AC capacitor have current collectors with through-holes 244, 246. In this embodiment, LMO cathode 232, LTO anode 242 and both AC capacitors 236, 238 were formed with current collector foils having no through-holes.

Again, it is found the function and durability of hybrid cell 230 is enhanced when the flow of lithium ions into and out of the LTO cathode 234 facing one side of the positively-charged AC capacitor 236, and the LMO anode 244 facing on side of the negatively-charged AC capacitor 238 are enhanced by the through-hole-containing copper or aluminum current collector foils 244, 246 used in these battery electrodes. Lithium cations are intercalated into and out of the LTO electrodes and LMO electrodes while lithium cations are adsorbed into released from the activated carbon particles of the AC capacitors. These different transport requirements of lithium cations and the corresponding electrolyte anions between the battery electrodes and capacitor electrode are preferably enhanced by the use of suitable through-hole structures in the LTO and LMO current collectors used in the battery electrodes 234, 240 facing the AC capacitors 236, 238.

In general, with respect to the hybrid cell embodiment of FIG. 3A, it is preferred that the capacity of the LMO electrode 202 plus one-half the capacity of the AC electrode 204 be in the range of 1.3 to 0.8 times the capacity of the interposed LTO anode 206. These capacities are determined by the compositions and sizes of the respective electrodes. And with respect to the hybrid cell embodiment of FIG. 3B, with its paired AC+ and AC− capacitor electrodes 236, 238, it is preferred that the capacity of the LMO cathode 232 and one-half the capacity of the AC+ electrode 236 on opposite sides of an LTO anode 234 be in the proportion of LMO+½ AC equals 1.3 to 0.8 times the capacity of the LTO 234 anode. And it is preferred that the hole sizes in current collector foils be in the range of 5 to 5000 μm and that the total hole area be about 0.1 to 50% of the area of the current collector foil to be coated with electrode material.

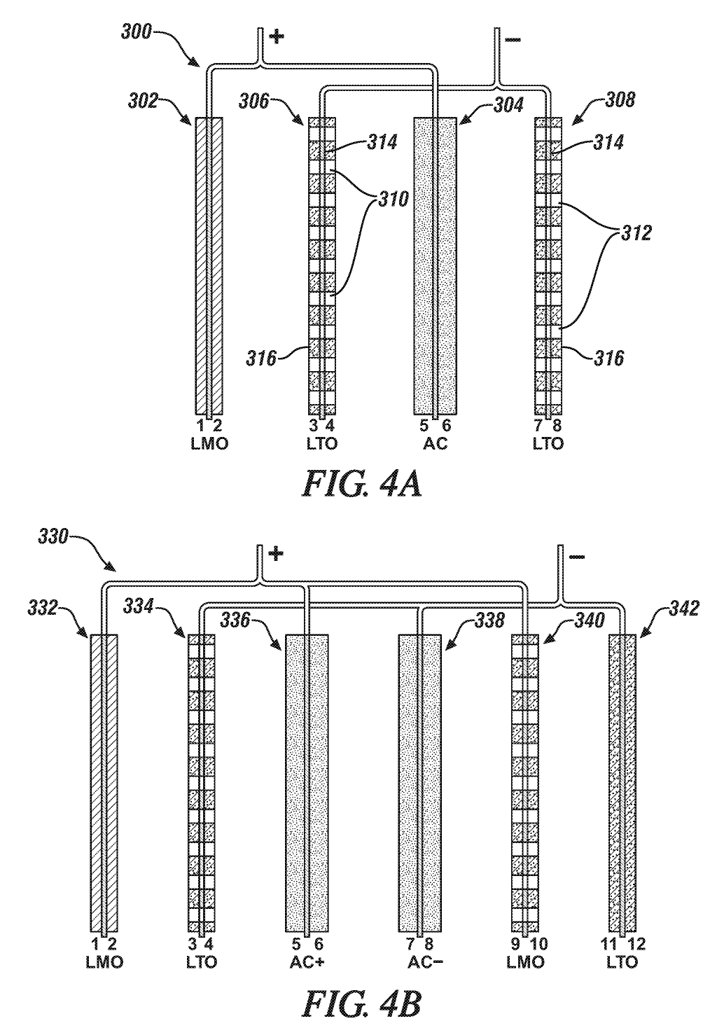

In FIG. 4A, hybrid cell 300 has two negatively-charged lithium titanate (LTO) electrodes 306, 308, a positively-charged lithium manganese oxide (LMO) cathode 302 and a positively-charged, activated carbon (AC) capacitor electrode 304. In this illustrated embodiment, the two LTO electrodes 306, 308, facing electrode material-bearing sides of the AC capacitor 304 are formed with through-holes 310, 312 that extend through each whole electrode. As schematically illustrated in FIG. 4A, the through-holes 310, 312 in both LTO electrodes 306, 308 extend through both porous, particulate layers of lithium titanate 314 and the copper current collector foil 316 to which the LTO electrode layers have been applied. In this embodiment, the through-holes 310, 312 are suitably formed by punching micrometer-size holes through the electrode material and the current collector from one side of the electrode material to the other side.

In this illustrated embodiment, The LMO cathode 302 and its electrically-connected AC capacitor 304 are formed with their respective particulate battery and capacitor compositions bonded as porous electrode layers to both sides of solid (no through-hole-containing) current collector foils.

In FIG. 4B, the hybrid cell has two negatively-charged (LTO) electrodes 334, 342 with an interposed negatively-charged AC capacitor electrode 338 and two positively-charged LMO cathodes 332, 340 and a positively-charged, AC capacitor electrode 336. In this illustrated embodiment, the LTO electrode 334 facing the positively-charged AC capacitor 336 and the LMO cathode 340 facing the negatively-charged AC capacitor 338 are formed with through-holes that extend through each whole electrode. In this embodiment, the through-holes are suitably formed by punching micrometer-size holes through the electrode material of the LTO electrode 334 and the LMO electrode 340 and their current collectors from one side of the electrode material to the other side of each battery electrode.

Again, in the hybrid cell embodiments illustrated in FIGS. 4A, 4B, it is preferred that the capacities of a capacitor electrode and a battery electrode on opposite sides of an interposed battery electrode be balanced in the range of about 1.3 to 0.8 times the capacity of the surrounded battery electrode.

In the illustrated embodiments, each hybrid cell was formed with an equal number (two or three) of positive and negative electrodes and included at least one capacitor electrode. Such hybrid cells may be formed of a larger grouping of positive and negative electrodes including capacitor electrodes.

### Experimental Example

Two hybrid cells of twelve electrodes were formed for comparative testing, each cell comprising six LTO anodes, five LMO cathodes, and one AC capacitor electrode. The hybrid cells were assembled with a central group of four electrodes consisting of a LMO cathode, a LTO anode, an AC capacitor electrode, and a LTO anode. The arrangement of the central group of four electrodes was like that illustrated in FIG. 4A of this specification. The current collectors in each electrode were aluminum foils of like rectangular shape, with tabs on one side, and having a thickness of about twenty micrometers. Each electrode was formed with a porous layer of resin-bonded particles of electrode material on both sides of the aluminum current collectors. But the two LTO anodes, to be placed adjacent the AC capacitor electrode, were formed with through-holes formed (punched) through the aluminum current collector foil and through the resin-bonded layers of lithium titanate particles applied to both sides of the current collector. Each of the other current collectors in the hybrid cells were formed without through-holes in the foils or the electrode material. Two outer groups of four electrodes, each comprising two LTO anodes alternating with two LMO cathodes, completed the assembly of electrodes of the twelve-electrode member cells. Thin, porous polypropylene separators (about 20 micrometers in thickness) were placed between the electrodes.

The LMO cathodes were formed by applying a mixture of micrometer-size lithium manganese oxide particles, conductive carbon particles, and polyvinylidene difluoride (PVDF, in solution), in weight proportions of 88.5/8.3/3 to the surfaces of rectangular aluminum foils (20 μm thick) of side dimensions of 55 mm by 50 mm (not including a tab formed on one side). After removal of the solvent for the resin, the thicknesses of the porous resin-bonded layers of LMO on each side of the aluminum foils was about 27 μm.

The LTO anodes were formed by applying a mixture of micrometer-size lithium titanate particles, conductive carbon particles, and polyvinylidene difluoride (PVDF, in solution), in weight proportions of 89.5/5/5.5 to the surfaces of rectangular aluminum foils (20 μm thick) of side dimensions of 57 mm by 52 mm (not including a tab formed on one side). After removal of the solvent for the resin, the thicknesses of the porous resin-bonded layers of LTO on each side of the aluminum foils was about 16 μm.

In one of the hybrid cells, two of the LTO anodes, to be placed adjacent to the sides of the AC capacitor electrode, were formed with 1014 round punched holes (r=0.1 mm) distributed as generally uniform 39 rows with 26 holes per row. The holes were punched through the layers of LTO particles and the central aluminum current collector foil as illustrated in FIG. 4A. It is estimated that the total area of the holes was about 1.07 percent of the superficial area of the rectangular faces of the aluminum current collector foils.

The AC capacitor electrode was formed by applying a mixture of micrometer-size activated carbon particles and polyvinylidene difluoride (PVDF, in solution), in weight proportions of 90/10 to the surfaces of rectangular aluminum foils (20 μm thick) of side dimensions of 55 mm by 50 mm (not including a tab formed on one side). After removal of the solvent for the resin, the thicknesses of the porous resin-bonded layers of AC on each side of the aluminum foil was about 100 μm.

It was estimated that the electrochemical capacity proportions of capacitor electrode material to battery electrode material was 8:92. The electrochemical capacity of the twelve-electrode hybrid cell was 135 mAh.

The non-aqueous liquid electrolyte was a 1.2M solution of LiPF6 dissolved in a solvent mixture of ethylene carbonate, dimethyl carbonate, and ethylmethyl carbonate (1:1:2, v/v). After the electrodes with interposed separators had been assembled in a container package, liquid electrolyte was carefully added to the assembly at atmospheric pressure (dew point: −41° C.). Infiltration of the added electrolyte into the close-fitting hybrid was assisted by varying the pressure as follows: (60 mBar, 2 min.)/1000 mBar, 1 min.)/(60 mBar, 2 min.)/1000 mBar, 1 min.)/60 mBar, 2 min)/sealing.

In the following tests, two twelve-electrode hybrid cells were tested and compared. One of the twelve-electrode cells was assembled with two through-hole-formed LTO anodes on each side of an AC capacitor electrode and a LMO cathode (like the arrangement in FIG. 4A of this specification). No other electrode in that 12-electrode cell was formed with any through-holes. And a like assembled 12-electrode hybrid cell was used which had no through-hole-containing aluminum current collectors.

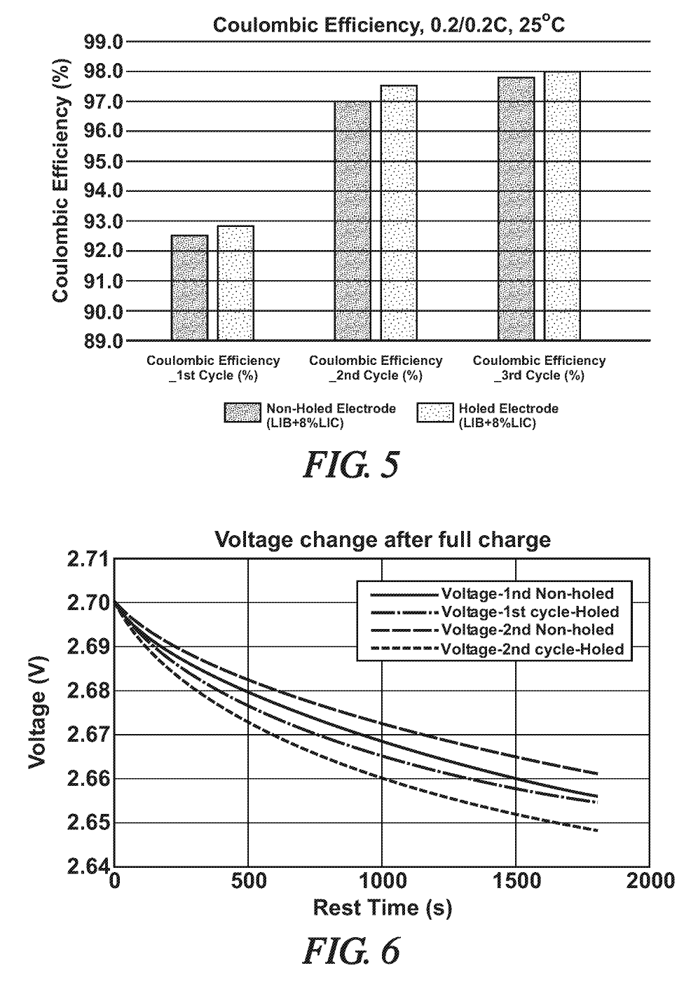

In separate tests, the holed-LTO electrodes cell and the non-holed LTO electrodes cell were each charged and discharged three times at 0.2 current capacity, which was 27 mA (0.2 times 135 mAh). Their columbic efficiencies in each of the three cycles were determined by the proportion of discharge capacity/charge capacity. These values for the through-hole-containing hybrid cell (like FIG. 4A) and the non-through-hole-containing hybrid cell are presented in the graph of FIG. 5.

It is seen that the hybrid cell with the through-hole-containing LTO electrodes adjacent the AC capacitor electrode consistently provided a higher coulombic efficiency than the like composed and assembled hybrid cell without the presence of the LTO electrodes formed with through-hole-containing aluminum current collector foils.

It has been found that hybrid cells. utilizing at least some through-hole-containing electrodes or through-hole-containing current collectors, can effectively decrease the occurrence of irreversible capacity in the cells.

Further, as illustrated in the graph of FIG. 6, voltage change of the holed cell fell more rapidly to its rest voltage during rest time that the like composed, non-holed hybrid cell. FIG. 6 shows that the open-circuit voltage of holed-electrodes in a hybrid cell more quickly reach a steady-state value. The shorter time in reaching a steady state voltage value is a result of forming of at least selected electrodes enhances the flow of the electrolyte and it ions through the closely assembled electrodes.

The above examples are intended to illustrate practices of the invention. But these illustrations are not limitations on the scope of the invention. It is clear that the selected use of thorough-holes in selected electrodes of a hybrid battery capacitor cell with closely packed electrodes and separators can significantly improve the performance of such hybrid cells. The improvement in such performance is particularly significant is enhancing ion flow between a capacitor electrode and an adjacent battery electrode.

1. An electrochemical cell comprising an assembly of at least two pairs of stacked or wound rolls of facing electrodes of opposed electrical charge, each electrode consisting of a two-sided, metal current collector foil, coated on both sides with a porous layer of particles of the same electrode material, the coated layers of electrode material being one selected from the group consisting of (i) a lithium ion intercalating/de-intercalating anode material for a lithium-ion battery, (ii) a lithium ion intercalating/de-intercalating cathode material for a lithium-ion battery, and (iii) a lithium ion, or compatible electrolyte anion, adsorbing/desorbing capacitor material, the porous layers of each electrode being separated from a facing layer of an adjacent electrode by a co-extensive porous separator layer, the porous layers of each electrode and each separator being infiltrated with a non-aqueous liquid electrolyte conductive of lithium ions and compatible anions;
the assembly of the at least two pairs of facing, opposing electrical charge electrodes including at least one electrode of capacitor material electrically connected with a lithium-ion battery electrode and facing an electrode of opposing electrical charge of lithium-ion battery anode material or an electrode of lithium-ion battery cathode material;
the assembly of the at least two pairs of facing, opposing electrical charge electrodes being further characterized in that at least one electrode is formed with a pattern of through-holes, formed through the current collector foil or through the coatings of porous layers of electrode particles and the current collector foil, the pattern of through-holes serving to permit the flow of the liquid electrolyte and its lithium ions and compatible anions through the current collector foil; and
the coating layers on the at least two pairs of opposing electrodes being selected to obtain a predetermined combination of energy density (Wh/kg) and power density (W/kg) for the electrochemical cell.

2. An electrochemical cell as stated in claim 1 in which each electrode in the electrochemical cell comprises through-holes formed through the current collector foil or through the current collector foil and through each layer of electrode material coated on the current collector foil.

3. An electrochemical cell as stated in claim 1 in which the through-holes formed through the current collector foil have diameters or largest dimensions in the range of five to five thousand micrometers and the total area of the through-holes is no greater than about fifty percent of the total area of the current collector foil that is coated with electrode material.

4. An electrochemical cell as stated in claim 1 in which the through-holes formed through the current collector foil have diameters or largest dimensions in the range of five to five hundred micrometers and the total area of the through-holes is no greater than about ten percent of the total area of the current collector foil that is coated with electrode material.

5. An electrochemical cell as stated in claim 1 in which the current collector foils are formed of copper or aluminum and have thicknesses in the range of four to twenty-five micrometers.

6. An electrochemical cell as stated in claim 1 in which battery anodes comprise particles of lithium titanate, battery cathodes comprise particles of lithium manganese oxide, and capacitor electrodes comprise particles of activated carbon.

7. An electrochemical cell as stated in claim 1 in which the battery anodes comprise particles of at least one of graphite, lithium titanate, silicon, alloys of silicon with lithium or tin, and silicon oxides.

8. An electrochemical cell as stated in claim 1 in which the battery cathodes comprise particles of at least one of lithium manganese oxide, lithium nickel oxide, lithium cobalt oxide, lithium-nickel manganese cobalt oxide, and lithium iron phosphate.

9. An electrochemical cell as stated in claim 1 in which the capacitor electrodes comprise particles of activated carbon.

10. An electrochemical cell as stated in claim 1 in which only those battery electrodes facing a capacitor electrode have through-holes formed through the current collector foil or through the current collector foil and through each layer of electrode material coated on the current collector foil.

11. An electrochemical cell as stated in claim 10 in which one-half the measured lithium ion-adsorbing capacity or anion-adsorbing capacity of the capacitor material, plus the capacity of the battery electrode to which it is electrically connected, is equal to 0.8-1.3 times the capacity of the facing battery electrode with through-holes formed through its current collector foil.

12. An electrochemical cell as stated in claim 1 comprising a pair of like electrically-charged battery anodes are assembled with a capacitor electrode and a like electrically charged battery cathode, the capacitor electrode being assembled between the anodes in the electrochemical cell, and the anodes being formed with either through-holes in the anode current collector foils or with through-holes extending through the anodes.

13. An electrochemical cell as stated in claim 12 in which the capacitor electrode and the cathode are formed without through-holes.

14. An electrochemical cell as stated in claim 1 comprising a battery anode, electrically connected with a negatively-charged capacitor electrode, and a battery cathode, electrically connected with a positively-charged capacitor electrode, the capacitor electrodes being assembled adjacent to each other in the electrochemical cell, the anode electrode and the cathode electrode being formed with either through-holes in their current collector foils or with through-holes extending through the anode electrode and the cathode electrode.

15. An electrochemical cell as stated in claim 14 in which the capacitor electrodes are formed without through-holes.

16. An electrochemical cell comprising an assembly of at least two pairs of stacked or wound rolls of facing electrodes of opposed electrical charge, each electrode consisting of a two-sided current collector strip coated on both sides with a porous layer of particles of an electrode material, the porous layers of each electrode being separated from a facing layer of an electrode by a co-extensive porous separator layer, the porous layers of each electrode and each separator being infiltrated with a non-aqueous liquid electrolyte of lithium ions and compatible anions;
the porous layers that are coated on each two-sided current collector strip being selected from the group consisting of (i) a layer of lithium-ion battery anode material on both sides of the current collector, (ii) a layer of lithium-ion battery cathode material on both sides of the current collector, and (iii) a layer of capacitor material on both sides of the current collector;
the assembly of the at least two pairs of facing, opposing electrical charge electrodes being further characterized in that each battery cathode or anode material electrode with at least one side facing a capacitor electrode is formed with a pattern of through-holes formed through the current collector or through the current collector and the coatings a porous layer of battery electrode particles, the capacitor electrode containing no through-holes, the pattern of through-holes in the facing battery electrode serving to permit the flow of the liquid electrolyte and its lithium ions and compatible anions through the current collector; and
the coating layers on the at least two pairs of opposing electrodes being selected to obtain a predetermined combination of energy density (Wh/kg) and power density (W/kg) for the electrochemical cell.

17. An electrochemical cell as stated in claim 16 in which the hybrid cell comprises a group of four electrodes comprising a pair of electrically connected anode electrodes each facing a capacitor electrode which is electrically connected to a battery cathode, and both anode electrodes are formed with through-holes, but the capacitor electrode and the cathode electrode are not formed with through-holes.

18. An electrochemical cell as stated in claim 17 in which the anode electrodes are the only electrodes in the hybrid cell which are formed with through-holes.

19. An electrochemical cell as stated in claim 16 in which the hybrid cell comprises a group of six electrodes comprising (i) two anodes electrically connected with an interposed negatively-charged capacitor and (ii) two cathodes electrically connected with an interposed positively-charged capacitor, the capacitors being assembled next to each other, the negatively charged capacitor facing a cathode and the positively charged capacitor facing an anode, the facing cathode and facing anode being formed with through-holes but the capacitors are not formed with through-holes.

20. An electrochemical cell as stated in claim 19 in which the stated cathode and anode are the only electrodes in the hybrid cell which are formed with through-holes.
